(19) United States
(12) Patent Application Publication
(10) Pub. No.: US 2021/0334057 A1
(43) Pub. Date: Oct. 28, 2021

(54) DISPLAY SYSTEM AND DISPLAY DEVICE

(71) Applicant: SHARP KABUSHIKI KAISHA, Osaka (JP)

(72) Inventor: MASAFUMI OKIGAMI, Osaka (JP)

(21) Appl. No.: 17/240,893

(22) Filed: Apr. 26, 2021

(30) Foreign Application Priority Data
Apr. 28, 2020 (JP) 2020-079755

(51) Int. Cl. G06F 3/14; H04L 29/08; G09F 9/30

(52) U.S. Cl. CPC G06F 3/14; H04L 67/146; G06F 3/041; G09F 9/30; H04L 67/12

(57) ABSTRACT

In a display system including a display device that displays content on the basis of a playlist, a terminal device, and a server device, the terminal device transmits specific information acquired from the display device and content information regarding content, from the terminal device to the server device, the server device transmits acquisition information generated. by the specific information and the content information to the display device, and the display device adds the content to the playlist on the basis of the acquisition information.

### BACKGROUND OF THE INVENTION

### Field of the Invention

The present invention relates to a display system or the like.

### Description of the Background Art

In recent years, in places such as shopping malls and public institutions, a mechanism (digital signage) for transmitting information such as advertisements, sales promotion/spatial production, and various kinds of guidance with the use of an electronic display device such as a display has been used.

Various techniques related to digital signage have also been proposed. For example, a technique has been proposed in which image data generated by an image forming apparatus is transmitted to a digital signage apparatus to thereby change the content of a notification image displayed by the digital signage apparatus (see, for example, Japanese Unexamined Patent Application Publication No. 2016-96509).

In addition, a technique has been proposed in which a mobile information terminal that has acquired a display ID from an identification code displayed on a signage display obtains a program menu by transmitting the display ID to a content server, and requests the content server to display desired related content from the program menu, thereby displaying the related content on the signage display (see, for example, Japanese Unexamined Patent Application Publication No. 2014-17581).

In the conventional digital signage, in order to display a file (content) on the digital signage, it is necessary to register a file in a signage system that manages the digital signage. For example, in order to display a file stored in a terminal device on a display device, it is necessary to transfer the file from the terminal device to a personal computer by way such as E⁻mail, process and edit the file with the use of a signage application, and then register the file in the signage system, and deliver the file from the signage system to the display device. Therefore, there is a problem that a great deal of time and effort is required. Such a problem is not considered in Japanese Unexamined Patent Application Publication No. 2016-96509 and Japanese Unexamined Patent Application Publication No. 2014-17581.

In order to solve the above-mentioned problem, it is an object of the present invention to provide a display system or the like capable of displaying content on a display device by a simple method.

### SUMMARY OF THE INVENTION

A first embodiment for solving the above-mentioned problems is a display system(for example, a display system in FIG. 1) including a display device that displays content on the basis of a playlist (for example, a display device 20 in FIG. 1, a display device 24 in FIG. 16, a signage displayer 202 in FIGS. 3 and 16, S132 in FIGS. 7, and S270 and S278 in FIG. 15), a terminal device (for example, a terminal device 10 in FIG. 1), a server device (for example, a storage server 30 in FIG. 1, a storage server 32 in FIG. 11, and a storage server 34 in FIG. 17). The terminal device transmits specific information acquired from the display device (for example, S120 in FIGS. 7, and S258 in FIG. 15) and content information regarding the content, from the terminal device to the server device (for example, S122 in FIGS. 7, and S260 in FIG. 15). The server device transmits the acquisition information generated by the specific information and the content information to the display device (for example, S124 and S126 in FIGS. 7, and S262 and S264 in FIG. 15). The display device adds the content to the playlist on the basis of the acquisition information (for example, S130 in FIGS. 7, and S268 and S276 in FIG. 15).

A second embodiment for solving the above-mentioned problems is a display device that displays content on the basis of a playlist (for example, a display device 20 in FIG. 1, a display device 24 in FIG. 16, a signage displayer 202 in FIGS. 3 and 16, S132 in FIGS. 7, and S270 and S278 in FIG. 15. The display device includes a displayer that displays specific information (for example, a two-dimensional code displayer 204 in FIGS. 3, and S114 in FIG. 7) and an adder (for example, a controller 200 in FIGS. 3, and S130 in FIG. 7) that adds the content to the playlist on the basis of the acquisition information acquired from the server device that generates the acquisition information. The acquisition information is information generated by the specific information and file information transmitted from the terminal device to the server device (for example, S122 and S124 in FIGS. 7, and S260 and S262 in FIG. 15).

According to the present invention, it is possible to display content on a display device by a simple method.

### BRIEF DESCRIPTION OF THE DRAWINGS

FIG. 1 is a diagram for explaining an overall configuration of a display system in a first embodiment.

FIG. 2 is a diagram for explaining a functional configuration of a terminal device in the first embodiment.

FIG. 3 is a diagram for explaining a functional configuration of a display device in the first embodiment.

FIG. 4 is a table illustrating an example of a data structure of a playlist in the first embodiment.

FIG. 5 is a diagram for explaining a functional configuration of a storage server in the first embodiment.

FIG. 6 is a diagram for explaining a functional configuration of a management server in the first embodiment.

FIG. 7 is a sequence diagram for explaining a flow of processing in the first embodiment.

FIG. 8 is a table for explaining device information in the first embodiment.

FIGS. 9A to 9D indicate a diagram for explaining an example of operation in the first embodiment.

FIGS. 10A and 10B indicate a diagram for explaining an example of operation in the first embodiment.

FIG. 11 is a diagram for explaining a functional configuration of a storage server in a second embodiment.

FIG. 12 is a diagram for explaining a functional configuration of a management server in the second embodiment.

FIG. 13 is a table illustrating an example of a data structure of management information in the second embodiment.

FIG. 14 is a sequence diagram for explaining a flow of processing in the second embodiment.

FIG. 15 is a sequence diagram for explaining a flow of processing in the second embodiment.

FIG. 16 is a diagram for explaining a functional configuration of a display device in a third embodiment.

FIG. 17 is a diagram for explaining a functional configuration of a storage server in the third embodiment.

FIG. 18 is a diagram for explaining a functional configuration of a management server in the third embodiment.

FIG. 19 is a sequence diagram for explaining a flow of processing in the third embodiment.

FIGS. 20A and 20B indicate a diagram for explaining an example of operation in the third embodiment.

### DESCRIPTION OF THE PREFERRED EMBODIMENTS

Hereinafter, an embodiment of the present invention will be described with reference to the drawings. In the present embodiment, a display system to which the present invention is applied will be described as an example.

### 1. First Embodiment

### 1.1 Overall Configuration

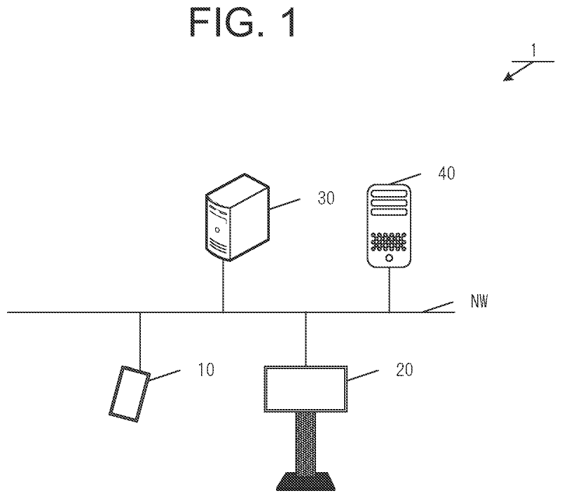

The overall configuration of a display system 1 of the present embodiment will be described on the basis of FIG. 1. As illustrated in FIG. 1, in the display system 1, a terminal device 10, a display device 20, a storage server 30, and a management server 40 are connected via a network NW. The network NW is, for example, a LAN (Local Area Network), but may be any network such as the Internet as long as the devices can exchange information with each other.

The terminal device 10 is an information processing device including, for example, a smartphone, a tablet, a PC (Personal Computer), or the like. The display device 20 is an information processing device including a displayer for displaying content. The storage server 30 and the management server 40 are devices that provide predetermined functions and services, and are information processing devices including a server device or the like.

### 1.2 Functional Configuration

### 1.2.1 Terminal Device

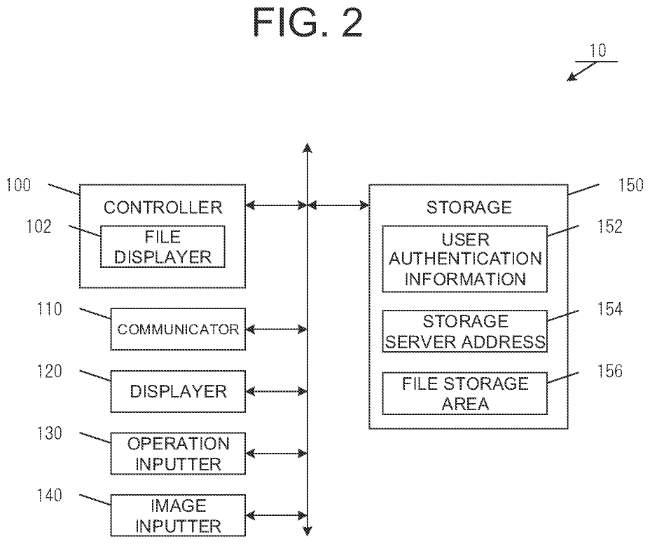

The functional configuration of the terminal device 10 will be described with reference to FIG. 2.

A controller 100 is a functional unit for controlling the entire terminal device 10. The controller 100 reads and executes various programs stored in a storage 150 to thereby implement various functions, and includes one or more computing devices (for example, CPUs (Central Processing Units)).

The controller 100 functions as a file displayer 102 by reading and executing a program stored in the storage 150.

The file displayer 102 is a functional unit that displays a file (content) on the displayer 120, accepts an operation of selecting a file from a user, and displays the selected file. The file may be a file stored in a file storage area 156 secured in the storage 150, or may be a file stored in an other device. The files stored in the other device are, for example, a file stored (registered) in a file storage area 324 of the storage server 30, a file stored (registered) in a storage service (cloud storage) on a cloud, and a file stored in a NAS (Network Attached Storage).

A communicator 110 is a functional unit for the terminal device 10 to communicate with an external device such as the storage server 30. The communicator 110 includes, for example, a communication module that can be connected to an NIC used in a wireless LAN or an LTE (Long Term Evolution)/LTE-A (LTE-Advanced)/LAA (License-Assisted Access using LTE)/5G line.

The displayer 120 is a functional unit for displaying various information, and includes, for example, a liquid crystal display (LCD), an organic EL (OLED) display, or the like. An operation inputter 130 is a functional unit for receiving an operation of a user who uses the terminal device 10, and includes, for example, a touch panel or the like. A method for detecting an input on the touch panel may be any general detection method such as a resistive film type, an infrared type, an electromagnetic induction type, or a capacitive type. In the terminal device 10, the displayer 120 and the operation inputter 130 may be integrally formed.

An image inputter 140 is a functional unit that photographs the outside of the terminal device 10 and inputs same as image data. The image inputter 140 is configured as, for example, a camera including an image sensor.

The storage 150 is a functional unit that stores various programs and various data necessary for the operation of the terminal device 10. The storage 150 includes, for example, an SSD (Solid State Drive) which is a semiconductor memory.

In the storage 150, user authentication information 152 and a storage server address 154 are stored, and a file storage area 156 is further secured as a storage area.

The user authentication information 152 is information for authenticating the user who uses the terminal device 10, and for example, a password is stored.

The storage server address 154 is information on the address required for the terminal device 10 to connect to the storage server 30. The storage server address 154 is, for example, a URL (Uniform Resource Locator), an IP address, a MAC address, or the like.

The file storage area 156 is an area for storing a file. The file storage area 156 stores, for example, a file of image data input by the image inputter 140, a file created by the terminal device 10, a file received via the communicator 110, and the like.

### 1.2.2 Display Device

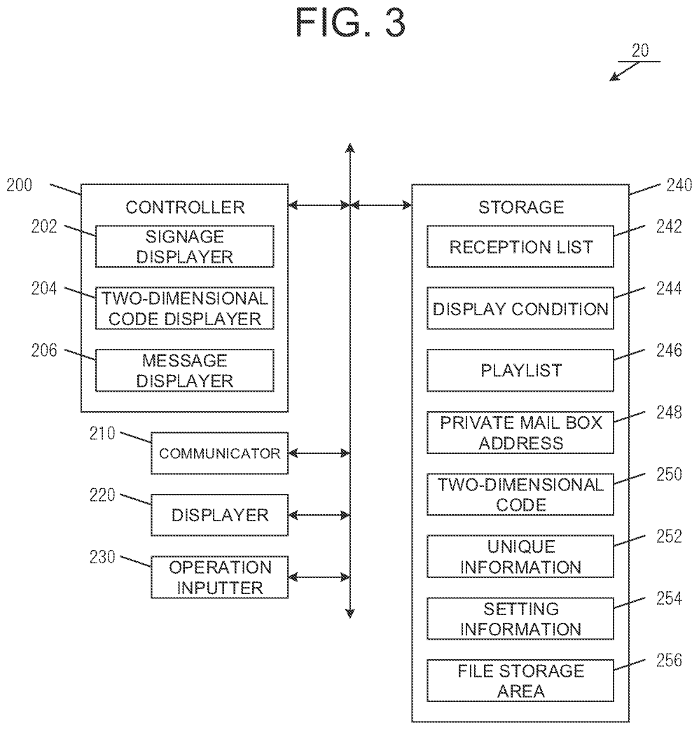

The functional configuration of the display device 20 will be described with reference to FIG. 3.

A controller 200 is a functional unit for controlling the entire display device 20. The controller 200 reads and executes various programs stored in a storage 240 to thereby implement various functions, and includes one or more computing devices (for example, CPUs).

A communicator 210 is a functional unit for the display device 20 to communicate with an external device such as the storage server 30. The communicator 210 includes, for example, a communication module such as an NIC used in a wired/wireless LAN.

A displayer 220 is a functional unit for displaying various types of information. For example, the displayer 220 includes a liquid crystal display, an organic EL display, an LED screen, or the like.

An operation inputter 230 is a functional unit for receiving an operation of a user who uses the display device 20, and includes, for example, a touch panel. A method for detecting an input on the touch panel may be any general detection method such as a resistive film type, an infrared type, an electromagnetic induction type, or a capacitive type. In the display device 20, the displayer 220 and the operation inputter 230 may be integrally formed. In addition, the operation inputter 230 may include a device that receives an electric signal output from a remote controller, or may include various operation devices such as a mouse and a keyboard.

The storage 240 is a functional unit that stores various programs and various data necessary for the operation of the display device 20. The storage 240 includes, for example, a semiconductor memory such as an SSD or an HDD (Hard Disk Drive).

In the storage 240, a reception list 242, a display condition 244, a playlist 246, a private mail box address 248, a two-dimensional code 250, unique information 252, and setting information 254 are stored, and a file storage area 256 is further secured as an area for storing a file.

The reception list 242 is a list for storing the acquisition information received from the private mail box identified by the private mail box address 248 described later. The acquisition information refers to information used when a file is acquired by the display device 20. The acquisition information is information including, for example, the URL of the file indicating a location where the file is stored, the path or file name of the file, the ID of the file, and the like. In the present embodiment, the acquisition information is the URL of the file. The private mail box will be described later.

The display condition 244 is data that stores a condition (setting) regarding the content (file) displayed by a signage displayer 202, which will be described later, and for example, the data stores the display time for each file. The display condition 244 is stored in advance by, for example, the administrator of the display device 20.

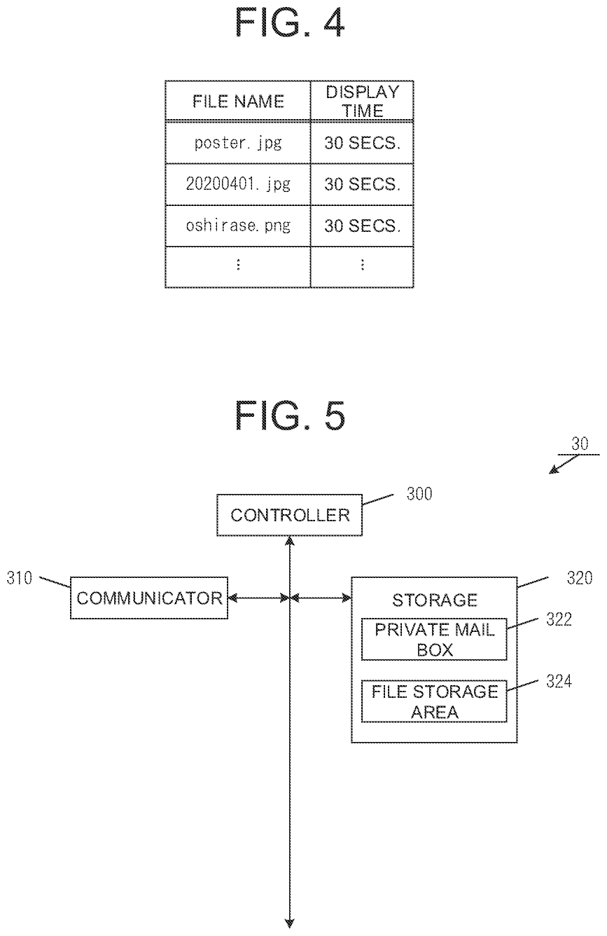

The playlist 246 is a table in which information (for example, a file name) for identifying a file stored in the file storage area 256 and the display time are arranged in order. For example, as illustrated in FIG. 4, the file name (for example, “poster.jpg”) and the display time (for example, “30 secs.”) are stored for each item.

The private mail box address 248 is the address of a private mail box corresponding to the display device 20, and is, for example, a URL, an IP address, a MAC address, or the like. In the present embodiment, the address of the private mail box will be described as a URL.

The two-dimensional code 250 is a code image indicating information (specific information) with which the private mail box corresponding to the display device 20 can be identified. The specific information is, for example, the address of the private mail box (for example, URL), the name of the private mail box, the attributes of the private mail box, and the like. In addition, the code image is, for example, a two-dimensional code, a one-dimensional code, a pattern/pattern, or the like. In the present embodiment, the code image will be described as a two-dimensional code.

The unique information 252 is information unique to the display device 20. For example, information such as a model name and a software version is stored in the unique information 252. In addition, the setting information 254 is information set by the administrator or the like of the display device 20, and for example, a group name, an organization name, a location, a latitude/longitude, a power supply schedule, and the like are stored.

The controller 200 functions as a signage displayer 202, a two-dimensional code displayer 204, and a message displayer 206 by reading and executing a program stored in the storage 240.

The signage displayer 202 is a functional unit that implements signage display. The signage display is a display method by which files are read out in a predetermined order and the content stored in the files is displayed on the displayer 220 for a predetermined time.

The signage displayer 202 reads out the file stored in the file storage area 256 in accordance with the playlist 246, and controls to display the content stored in the read file on the displayer 220 for the display time corresponding to the file. In addition, when the signage displayer 202 finishes displaying the content stored in the file identified by the file name stored in the last item of the playlist 246, the signage displayer 202 returns to the first item of the playlist 246 again and continues to display the content stored in the file in accordance with the playlist 246. In this way, the signage displayer 202 repeatedly displays the content stored in the file stored in the file storage area 256.

The two-dimensional code displayer 204 is a functional unit that controls the display (output) of the two-dimensional code which is the code image. For example, the two-dimensional code displayer 204 outputs by displaying the two-dimensional code 250 in a predetermined area of the displayer 220 when the signage display is not performed by the signage displayer 202. Meanwhile, the two-dimensional code displayer 204 does not output the two-dimensional code 250 in the displayer 220 when the signage display is performed by the signage displayer 202.

The message displayer 206 is a functional unit that displays a predetermined message on the displayer 220. The predetermined message is, for example, information regarding the state of the display device 20 or information regarding signage display (for example, new content has been added).

### 1.2.3 Storage Server

The functional configuration of the storage server 30 will be described with reference to FIG. 4.

A controller 300 is a functional unit for controlling the entire storage server 30. The controller 300 reads and executes various programs stored in a storage 320 to thereby implement various functions, and includes one or more computing devices (for example, CPUs).

A communicator 310 is a functional unit for the storage server 30 to communicate with an external device such as the display device 20 and the management server 40. The communicator 310 includes, for example, a communication module such as an NIC used in a wired/wireless LAN.

The storage 320 is a functional unit that stores various programs and various data necessary for the operation of the storage server 30. The storage 320 includes, for example, a semiconductor memory such as an SSD or an HDD.

In the storage 320, a file storage area 324 that is an area for storing a private mail box 322 and a file is secured. The file storage area 324 may, for example, store the file as it is, or may be a database in which the file and the ID that identifies the file are associated with each other.

The private mail box 322 is an area for storing acquisition information (acquisition information storage area). In the present embodiment, the private mail box 322 is, for example, a folder in which a shortcut file indicating the URL of the file is stored. In the private mail box 322, URL information of 0 or more files may be stored, and for example, the text data or a database may be stored. In addition, the private mail box 322 is a place where the display device 20 periodically checks to acquire a file, and is created (secured) for each display device 20.

### 1.2.4 Management Server

The functional configuration of the management server 40 will be described with reference to FIG. 5.

A controller 400 is a functional unit for controlling the entire management server 40. The controller 400 reads and executes various programs stored in a storage 420 to thereby implement various functions, and includes one or more computing devices (for example, CPUs).

A communicator 410 is a functional unit for the management server 40 to communicate with an external device such as the display device 20 and the storage server 30. The communicator 410 includes, for example, a communication module such as an NIC used in a wired/wireless LAN.

The storage 420 is a functional unit that stores various programs and various data necessary for the operation of the management server 40. The storage 420 includes, for example, a semiconductor memory such as an SSD or an HDD.

The storage 420 stores device information 422, a private mail box address 424, and a two-dimensional code 426. The device information 422 is information regarding the display device 20. The private mail box address 424 is the address of a private mail box address corresponding to the display device 20. The two-dimensional code 426 is a two-dimensional code indicating specific information of the private mail box corresponding to the display device 20.

### 1.3 Flow of Processing

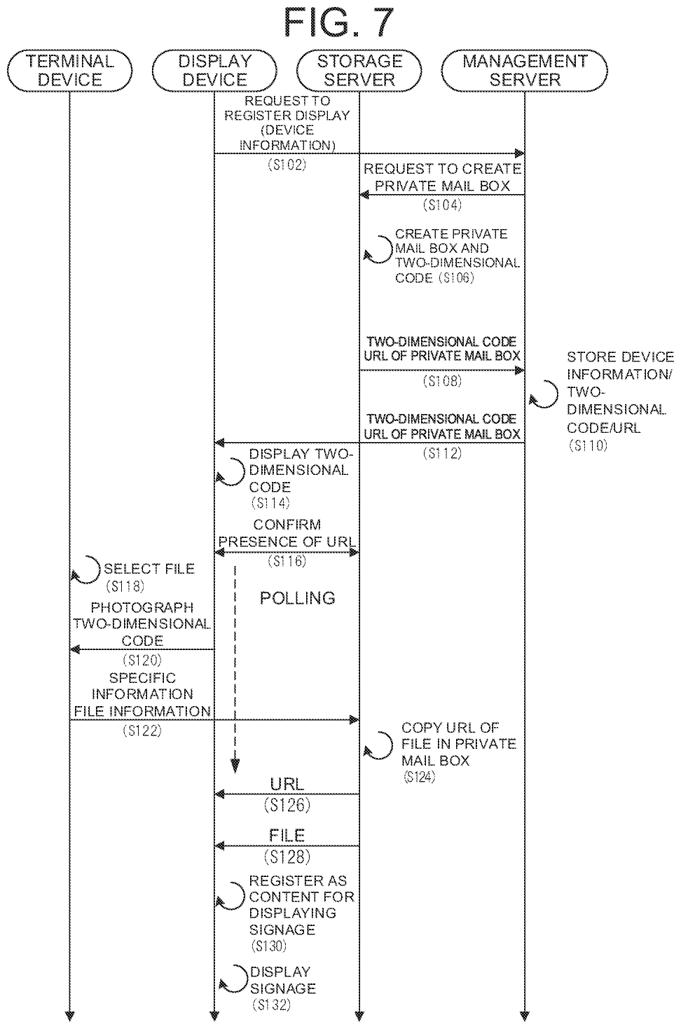

The flow of processing in the present embodiment will be described with reference to FIG. 7.

First, the display device 20 (controller 200) transmits a request to register a display to the management server 40 (S102). The request to register a display is a request for the display device 20 to be able to acquire acquisition information from the storage server 30.

When transmitting the request to register a display, the display device 20 (controller 200) also transmits information (device information) regarding the display device 20.

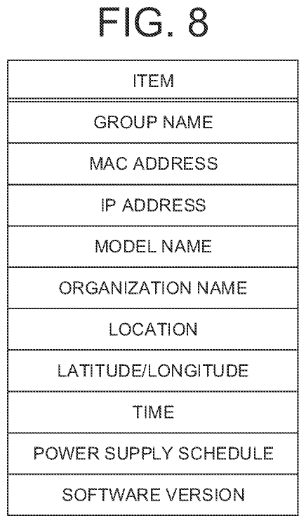

The device information is, for example, the information illustrated in FIG. 8. The display device 20 (controller 200) acquires necessary information and then transmits the necessary information as device information. For example, the display device 20 (controller 200) acquires the group name, model name, organization name, location, latitude/longitude, power supply schedule, and software version by reading out the information stored in the unique information 252 and the setting information 254. The display device 20 (controller 200) acquires the MAC address and the IP address by reading out the MAC address and the IP address assigned to the communicator 210. The display device 20 (controller 200) acquires the time on the display device 20 as for the time.

When receiving the request to register a display from the display device 20, the management server 40 (controller 400) transmits a request to create a private mail box to the storage server 30 (S104).

When receiving the request to create a private mail box, the storage server 30 (controller 300) creates (secures) the private mail box 322 in the storage 320, and further creates a two-dimensional code indicating the specific information of the private mail box 322 (for example, the URL of the private mail box 322) (S106). For example, the storage server 30 (controller 300) creates a two-dimensional code by encoding the URL of the private mail box 322 in a predetermined format. As a result, the two-dimensional code and the private mail box 322 specified by the specific information indicated by the two-dimensional code are associated with each other.

The storage server 30 (controller 300) may create a two-dimensional code on the basis of the attribute information such as the name, file path, and ID of the private mail box 322 as long as the private mail box 322 can be identified with the information.

The storage server 30 (controller 300) transmits the address of the private mail box 322 (the URL of the private mail box 322 in the present embodiment) and the two-dimensional code indicating the specific information of the private mail box 322 (for example, the URL of the private mail box 322) to the management server 40 (S108).

The management server 40 (controller 400) stores the device information received from the display device 20 as the device information 422. In addition, the management server 40 (controller 400) stores the address of the private mail box 322 and the two-dimensional code received from the storage server 30 as the private mail box address 424 and the two-dimensional code 426, respectively (S110). In this way, the management server 40 (controller 400) associates the device information, the address of the private mail box 322, and the two-dimensional code.

The management server 40 (controller 400) transmits the private mail box address 424 (URL of the private mail box 322 in the present embodiment) and the two-dimensional code 426 to the display device 20 (S112). The display device 20 (controller 200) stores the private mail box address 424 received from the management server 40 as the private mail box address 248, and stores the two-dimensional code 426 received from the management server 40 as the two-dimensional code 250. As a result, the display device 20 can acquire the address of the private mail box 322 created in the storage server 30 corresponding to the display device 20 and the two-dimensional code indicating the specific information of the private mail box 322.

Subsequently, the display device 20 (two-dimensional code displayer 204) reads out the two-dimensional code 250 and displays the two-dimensional code on the displayer 220 (S114). As a result, the display device 20 outputs the specific information of the private mail box corresponding to the display device 20.

In addition, the display device 20 (controller 200) connects to the private mail box 322 of the storage server 30 identified by the private mail box address 248, and starts polling for periodically confirming whether the URL which is the acquisition information is stored (S116).

The terminal device 10 (file displayer 102) selects and displays a file on the basis of the user's operation (S118).

In addition, the terminal device 10 (image inputter 140) photographs the two-dimensional code displayed (output) on the displayer 220 of the display device 20 on the basis of the user's operation, and analyzes the two-dimensional code, thereby acquiring specific information (for example, the URL of the private mail box) (S120).

The terminal device 10 (controller 100) connects to the storage server 30 with the use of the storage server address 154 on the basis of the user's operation. Then, the terminal device 10 (controller 100) transmits the specific information acquired in S120 and the information of the file selected in S118 to the storage server 30 via the communicator 110 (S122).

The file information may be the file per se selected by the user or a URL from which the file selected by the user can be downloaded.

The storage server 30 (controller 300) receives the specific information and the file information transmitted from the terminal device 10 via the communicator 310. The storage server 30 (controller 300) identifies a private mail box on the basis of the specific information, and generates the file acquisition information (URL in the present embodiment) based on the file information transmitted from the terminal device 10, in the identified private mail box. As a result, the storage server 30 (controller 300) can store (copy) the file acquisition information in the private mail box (S124).

With regard to identifying the private mail box, for example, if the specific information transmitted from the terminal device 10 is the URL of the private mail box, the storage server 30 (controller 300) identifies the private mail box from the URL. If the specific information transmitted from the terminal device 10 is information other than the URL of the private mail box (for example, the name of the private mail box or the attributes of the private mail box), the storage server 30 (controller 300) identifies a private mail box corresponding to the received specific information.

With regard to generating the acquisition information, for example, when receiving the file per se as the file information from the terminal device 10, the storage server 30 (controller 300) stores the received file in the file storage area 324, and stores the URL of the stored file in the private mail box identified by the specific information to thereby generate the acquisition information.

In addition, when receiving the URL as the file information from the terminal device 10, the storage server 30 (controller 300) downloads the file on the basis of the received URL and stores the downloaded file in the file storage area 324. Moreover, the storage server 30 (controller 300) stores the URL of the file stored in the file storage area 324, in the private mail box identified by the specific information, to thereby generate the acquisition information.

In addition, when receiving the file information stored in the file storage area 324 from the terminal device 10, the storage server 30 (controller 300) stores the URL of the file identified by the received file information, in the private mail box identified by the specific information, to thereby generate the acquisition information.

By configuring in this manner, the file based on the file information transmitted from the terminal device 10 is stored in the file storage area 324. Furthermore, the acquisition information is the URL of the file stored in the file storage area 324.

Here, by the polling started in S116, the display device 20 (controller 200) detects that the acquisition information (URL) is stored in the private mail box 322 corresponding to the display device 20. In this case, the display device 20 (controller 200) acquires the acquisition information (URL) stored in the private mail box 322 via the communicator 310 (S126). As a result, the storage server 30 transmits the acquisition information generated on the basis of the specific information and the file information received from the terminal device 10 to the display device 20. In addition, the display device 20 (controller 200) stores the acquired acquisition information in the reception list 242.

In doing so, the display device 20 (controller 200) compares the reception list 242 with the playlist 246, and detects a file newly added to the private mail box 322 and a file deleted from the private mail box 322.

For example, the display device 20 (controller 200) reads out the playlist 246 item by item, and determines whether the file identified by the file name of the read item matches any of the files stored in the URL stored in the reception list 242. In doing so, the display device 20 (controller 200) determines whether the file name stored in the item of the playlist 246 matches the file name portion of the URL. If none of the above matches, the display device 20 (controller 200) can detect that the file identified by the file name of the read item has been deleted from the private mail box. In this case, the display device 20 (controller 200) deletes the read item from the playlist 246, and deletes the file identified by the file name of the read item from the file storage area 256.

In addition, the display device 20 (controller 200) reads out the URL stored in the reception list 242 one by one, and determines whether the file stored in the read URL matches any of the files identified by the file name stored in the playlist 246. If none of the above matches, the display device 20 (controller 200) can detect that the file stored in the read URL is a file newly added to the private mail box. In this case, the display device 20 (controller 200) acquires the file from the storage server 30 via the communicator 310 on the basis of the read URL, and stores the file in the file storage area 256 (S128).

The display device 20 (controller 200) registers the acquired file as content for signage display (S130). Specifically, the display device 20 (controller 200) adds the file name of the file stored in the file storage area 256 in S128 to the end of the playlist 246, and then stores the playlist 246. In doing so, the display device 20 (controller 200) sets the display time of the added file on the basis of the display condition 244.

Subsequently, the display device 20 (signage displayer 202) starts signage display (S132). As a result, the display device 20 (signage displayer 202) displays the file added to the playlist 246 as the content in signage display. The display device 20 (signage displayer 202) may start the signage display after the operation to start the signage display is performed via the operation inputter 230.

### 1.4 Example of Operation

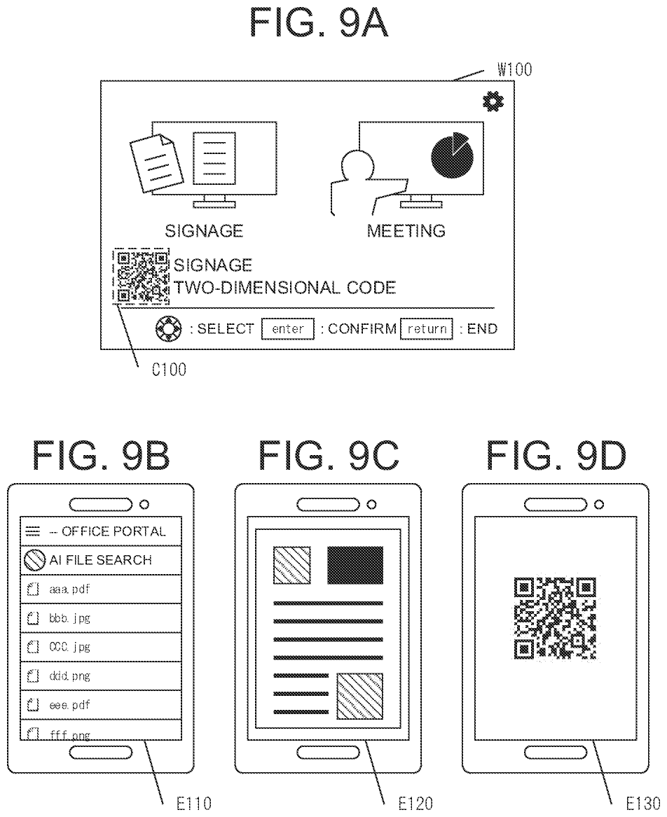

Subsequently, an example of operation in the present embodiment will be described with reference to the drawings. FIG. 9A is a display example of a menu screen W100 displayed on the displayer 220 of the display device 20. The menu screen is a screen in a state where the signage display is not executed. On the menu screen W100, for example, a two-dimensional code C100 with which the private mail box corresponding to the display device 20 can be identified is displayed.

FIG. 9B is a diagram illustrating a state where a screen for selecting a file is displayed in the terminal device 10. In the displayer 120 of the terminal device 10, as illustrated in an area E110, a list for selecting a file is displayed. The file selected by the user may be a file stored in the terminal device 10, or may be a file stored in the storage server 30 or an other cloud service. In addition, FIG. 9C is a diagram illustrating a state where the file selected by the user is displayed in an area E120 in the displayer 120 of the terminal device 10.

When the file is selected by the user, the terminal device 10 photographs the two-dimensional code displayed on the display device 20 to acquire the file. The acquired two-dimensional code is displayed in an area E130 in the displayer 120 of the terminal device 10 illustrated in FIG. 9D.

The user transmits the information of the selected file and the acquired two-dimensional code to the storage server 30. The operations of selecting the file, acquiring the two-dimensional code, transmitting the file information and the two-dimensional code to the storage server may be input via, for example, a dedicated application operating in the terminal device 10.

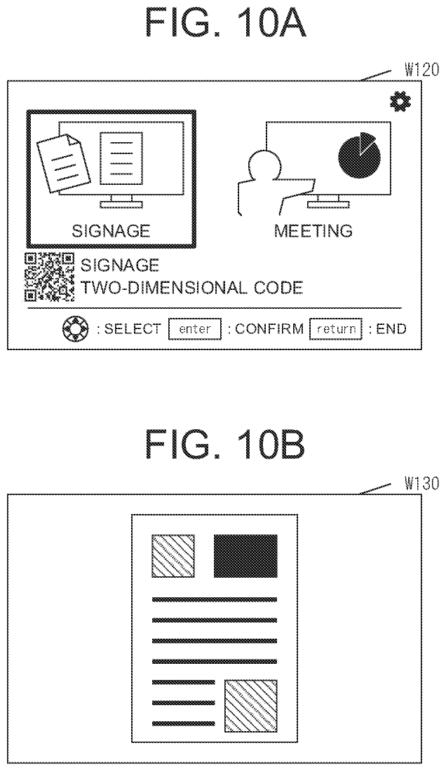

FIG. 10A is a display example of a menu screen W120 when the signage display is selected as the content display method by a remote controller or the like. For example, by emphasizing an icon indicating the signage display (for example, surrounding the icon with a frame, changing the background color, enlarging the icon, etc.), it is indicated that the signage display is selected. If a start instruction is given in this state, the signage display of the file registered as the content for signage display is started as illustrated in a display screen W130 of FIG. 10B.

The processing of the present embodiment may be changed as appropriate. For example, the signage displayer 202 may automatically perform the signage display after no operation continues for a certain period of time on the menu screen. The signage displayer 202 may display an image of the content that has been edited such as rotation, zooming, trimming, and margin deletion.

In addition, a camera may be installed above the display device 20, and the two-dimensional code displayer 204 may display the two-dimensional code 250 when the proximity of the terminal device 10 is detected.

Moreover, information (restriction information) regarding the display of the content may be added or included in the acquisition information. In this case, the display device 20 displays the content on the basis of the restriction information. The restriction information is, for example, information indicating when a file can be displayed. Specifically, when the file information is transmitted from the terminal device 10 to the storage server 30, the display start and/or end date and time of the file and the display period may be specified by the user. In this case, in S122, the terminal device 10 (controller 100) also transmits information on the display start and/or end date and time and the display period specified by the user. The storage server 30 (controller 300) stores the acquisition information including the display start and/or end date and time and the restriction information indicating the display period, in the private mail box 322. For example, in the present embodiment, in S124, the storage server 30 (controller 300) generates acquisition information in which the information specified from the terminal device 10 is added to the end or the like of the URL (for example, as a query parameter). In S130, the display device 20 (controller 200) stores a file acquired on the basis of the acquisition information including the restriction information, in the playlist 246 in association with the restriction information. In S132, the display device 20 (signage displayer 202) refers to the associated restriction information for the file associated with the restriction information, and determines whether it is the time when the file can be displayed. Then, the display device 20 (signage displayer 202) controls the displayer 220 to display the content stored in the file only when the file can be displayed. The display device 20 (signage displayer 202) displays a file for which the display start and/or end date and time and the display period are not specified, regardless of the time.

In addition, the restriction information may be information indicating the display time of the file. Specifically, when the file information is transmitted from the terminal device 10 to the storage server 30, the display time of the file may be specified. In this case, in S122, the terminal device 10 (controller 100) also transmits information on the display time specified by the user. In 5124, the storage server 30 (controller 300) adds the display time of the file specified by the terminal device 10 to the acquisition information as restriction information. In S130, the display device 20 (controller 200) stores the playlist 246 in such a manner that the file for which the display time is specified is displayed for the specified display time. The display device 20 (controller 200) stores the playlist 246 in such a manner that a file for which the display time is not specified is displayed for only the display time (fixed display time) based on the display condition 244. As a result, in S132, the display device 20 (signage displayer 202) controls to display the file on the displayer 220 as content on the basis of the display time.

In addition, the restriction information may be information indicating the attributes of the file (for example, a file format, a resolution, a file size, a frame rate, etc.). In this case, in S124, the storage server 30 (controller 300) adds the information indicating the attributes of the file to the end or the like of the URL as restriction information. When acquiring the URL from the storage server 30 in S126, if the information indicating the attributes of the file is added as the restriction information, the display device 20 (controller 200) refers to the restriction information and compares the attributes of the file with the capacity of the display device 20 (e.g., a supported format). As a result, the display device 20 (controller 200) determines whether the file stored in the URL can be displayed. In doing so, the display device 20 prevents the URL of the file that cannot be displayed from being stored in the reception list 242, on the basis of the determination. By configuring in this manner, in S126, the display device 20 (controller 200) can add only the files that can be displayed on the display device 20 to the playlist 246 and acquire them from the storage server 30 in 5128. As a result, in S132, the display device 20 (signage displayer 202) controls to display only the files that can be displayed on the display device 20. With regard to the URL to which the information indicating the attributes of the file is not added as the restriction information, the display device 20 (controller 200) does not determine whether the file can be displayed, and stores the URL in the reception list 242.

In addition, the restriction information may be information in which the above-mentioned information is combined. For example, the restriction information may be information that is a combination of information indicating when the file can be displayed and information regarding the attributes of the file.

In the above-described embodiment, the case where the management server 40 receives the request to register a display from one display device 20 has been described. However, the management server 40 may receive the request to register a display from a plurality of display devices 20. In this case, the management server 40 transmits a request to create a private mail box to the storage server 30 each time the management server 40 receives the request to register a display.

The storage server 30 creates (secures) a private mail box every time the storage server 30 receives the request to create a private mail box, and creates a two-dimensional code corresponding to the created private mail box. By configuring in this manner, the storage server 30 creates (secures) a private mail box for each display device 20. In doing so, the storage server 30 may use the file storage area after securing the file storage area corresponding to each private mail box, as an area for storing a file based on the file information transmitted from the terminal device 10, or may use a single file storage area 324 regardless of the private mail box.

The management server 40 stores the URL of the private mail box created by the storage server 30 and the two-dimensional code, in association with the device information of the display device 20. In this way, the private mail box 322 secured in the storage server 30 is associated with respective different display devices 20. In addition, the management server 40 transmits the corresponding two-dimensional code and the URL of the private mail box to the display device 20 that has transmitted the request to register a display.

As a result, the respective display devices 20 are associated with respective different private mail boxes and display two-dimensional codes different from each other. When receiving the specific information and the file information from the terminal device 10, the storage server 30 stores the file acquisition information based on the file information, in the private mail box identified by the specific information. The display device 20 can acquire the acquisition information stored in the private mail box identified by the URL of the private mail box transmitted from the management server 40, and can acquire a file on the basis of the acquisition information. Since the private mail box associated with each display device 20 is different, the acquisition information acquired by each display device 20 is also different, and the displayed content is also different. Therefore, the user photographs the two-dimensional code displayed on the display device 20 on which the content is to be displayed, and transmits the specific information indicated by the two-dimensional code and the file information to the storage server 30, and thereby can cause the display device 20 on which the two-dimensional code has been photographed to display content based on the file.

In the present embodiment, when the terminal device 10 transmits the file information to the storage server 30, the specific information is acquired by photographing the two-dimensional code output (displayed) on the display device 20. However, the method for acquiring the specific information may be an other method.

For example, the display device 20 may output the specific information with the use of NFC (Near field communication) or Direct Wifi. In this case, the terminal device 10 acquires the specific information by communicating with the display device 20.

In addition, the storage server 30 may receive the file information and specific information with the use of NFC or Direct Wifi. Moreover, the storage server 30 may set an e-mail address associated with the private mail box and display the e-mail address or information by which the e-mail address can be acquired may be displayed on the display device 20. In this case, the storage server 30 receives an e-mail with the file information attached, for an e-mail address that can be obtained from the display device 20. The storage server 30 stores a file based on the received file information, in the file storage area 324, and stores the URL of the file in the private mail box 322.

In addition, in S124, when acquiring a URL from which the file can be downloaded as the file information from the terminal device 10, the storage server 30 (controller 300) may store the acquired URL in the private mail box 322 without downloading the file. In this case, in S126, the storage server 30 (controller 300) transmits the URL from which the file received from the terminal device 10 can be downloaded, to the display device 20 as the acquisition information. In this case, in S128, the display device 20 (controller 200) downloads (acquires) the file on the basis of the acquisition information acquired from the display device 20.

### 1.5 Variation of First Embodiment

In the above-described embodiment, the acquisition information is stored in the private mail box 322, but the file information may be stored in the private mail box 322. As a result, the private mail box 322 stores the file per se and a URL from which the file can be downloaded.

Specifically, in S124, the storage server 30 (controller 300) stores the file information received from the terminal device 10, in the private mail box 322 identified on the basis of the specific information received from the terminal device 10.

The display device 20 (controller 200) skips the processing of S126, and acquires the file information from the private mail box 322 in the processing of S128. In this case, the file information stored in the private mail box 322 is the acquisition information.

The display device 20 (controller 200) acquires a file on the basis of the file information which is the acquisition information. For example, if the file information is the file per se, the file may be acquired as a file as it is. In addition, if the file information is a URL from which the file can be downloaded, the file may be acquired on the basis of the URL. The display device 20 (controller 200) stores the acquired file in the file storage area 256. Moreover, when a file stored in the file storage area 256 but not stored in the private mail box 322 is detected, the detected file is deleted from the file storage area 256. Then, the display device 20 (controller 200) adds the file name and display time of the acquired file to the playlist 246 in such a manner that the file stored in the file storage area 256 can be displayed by the signage displayer 202.

When the specific information is the address (for example, a URL) of the private mail box 322, the terminal device 10 may store the file information in the private mail box 322 identified by the address.

According to the present embodiment, when the display device has content (file) for signage display, the user may select the file with the use of the terminal device and transmit the file information and the specific information acquired by photographing the two-dimensional code, to the storage server. As a result, the file selected by the user is displayed as content on the display device. Therefore, it is not necessary to process and edit the file for signage display with a dedicated application and distribute the file to a display, and the content for signage display can be registered and displayed by a simple method.

In addition, since the information for identifying the private mail box is output (displayed) by the display device, the user does not need to know the information regarding the private mail box in advance. Moreover, the specific information is displayed on the display device by the two-dimensional code, and thus the user can obtain the information (specific information) of the private mail box simply by performing a simple operation of photographing the two-dimensional code.

### 2. Second Embodiment

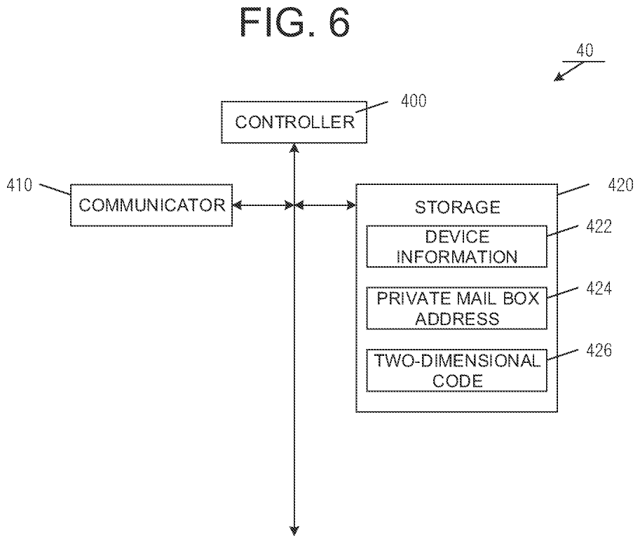

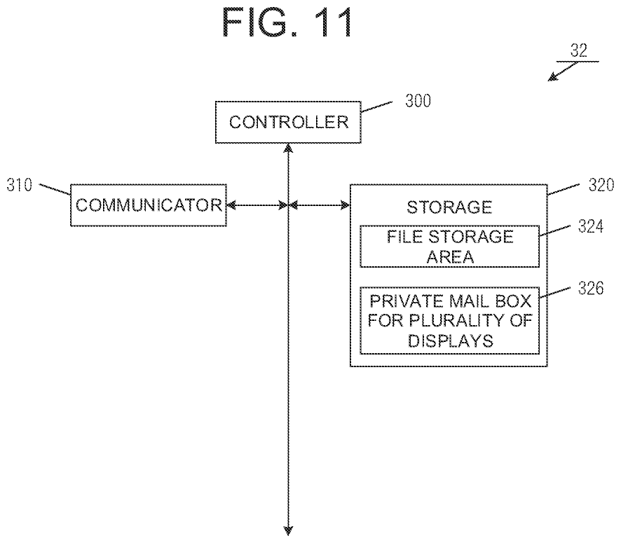

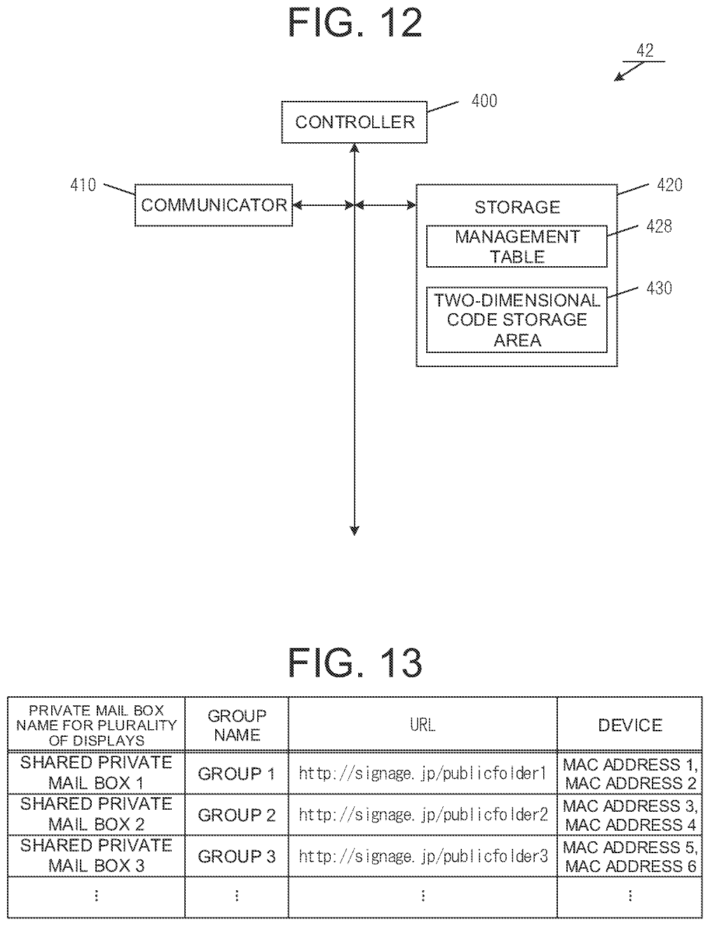

In a second embodiment, the private mail box is associated with a plurality of display devices. In the second embodiment, FIG. 5 of the first embodiment is replaced with FIG. 11, and FIG. 6 of the first embodiment is replaced with FIG. 12, and the same functional units and processing are denoted by the same reference numerals, and the description thereof will be omitted.

In the present embodiment, a private mail box shared (associated) by a plurality of display devices 20 by being associated with the plurality of display devices 20 is referred to as a private mail box for plurality of displays.

In the present embodiment, the display system 1 includes a storage server 32 as an alternative to the storage server 30, and a management server 42 as an alternative to the management server 40. In addition, it is assumed that a plurality of display devices 20 are connected to the display system 1 and the network NW.

The functional configuration of the storage server 32 in the present embodiment will be described with reference to FIG. 11. Unlike the storage server 30, the storage server 32 further secures a private mail box for plurality of displays 326 in the storage 320.

The private mail box for plurality of displays 326 is an area for storing acquisition information (acquisition information storage area). In the present embodiment, the private mail box for plurality of displays 326 is, for example, a folder in which a shortcut file indicating the URL of a file is stored, similarly to the private mail box 322 of the first embodiment. In the private mail box for plurality of displays 326, URL information of one or more files may be stored, and for example, text data or a database may be stored.

The functional configuration of the management server 42 in the present embodiment will be described with reference to FIG. 12. Unlike the management server 40, the management server 42 stores a management table 428 in the storage 420, and secures a two-dimensional code storage area 430 as an area for storing a two-dimensional code.

The management table 428 is a table in which information (management information) for managing the correspondence between the private mail box and the display device 20 corresponding to the private mail box is stored. For the management information, for example, as illustrated in FIG. 13, a name of a private mail box for plurality of displays (for example, “shared private mail box 1”) and a group name indicating a group of display devices 20 using the private mail box for plurality of displays (for example, “group 1”), a URL that is the address of the private mail box for plurality of displays (for example, “http://signage.jp/publicfolder1”), and device information of the display devices corresponding to the private mail box for plurality of displays (for example, “MAC address 1”, “MAC address 2”) are stored. In the present embodiment, the address of the private mail box will be described as a URL.

In the two-dimensional code storage area 430, a two-dimensional code for each private mail box for plurality of displays is stored. The two-dimensional code stored in the two-dimensional code storage area 430 is identified by, for example, the name of a private mail box for plurality of displays.

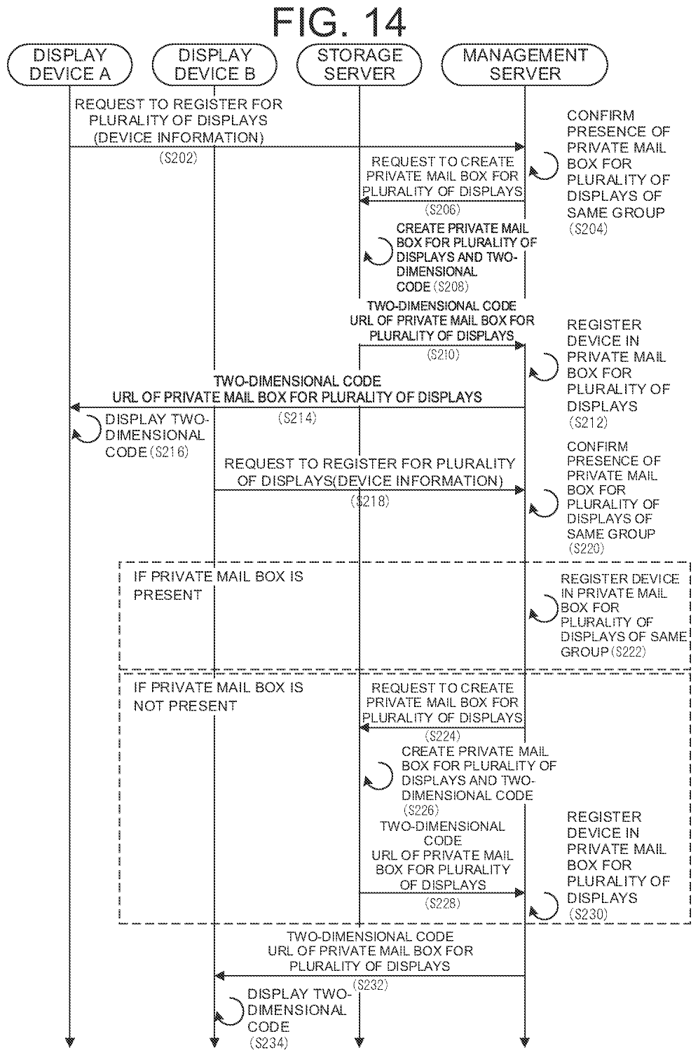

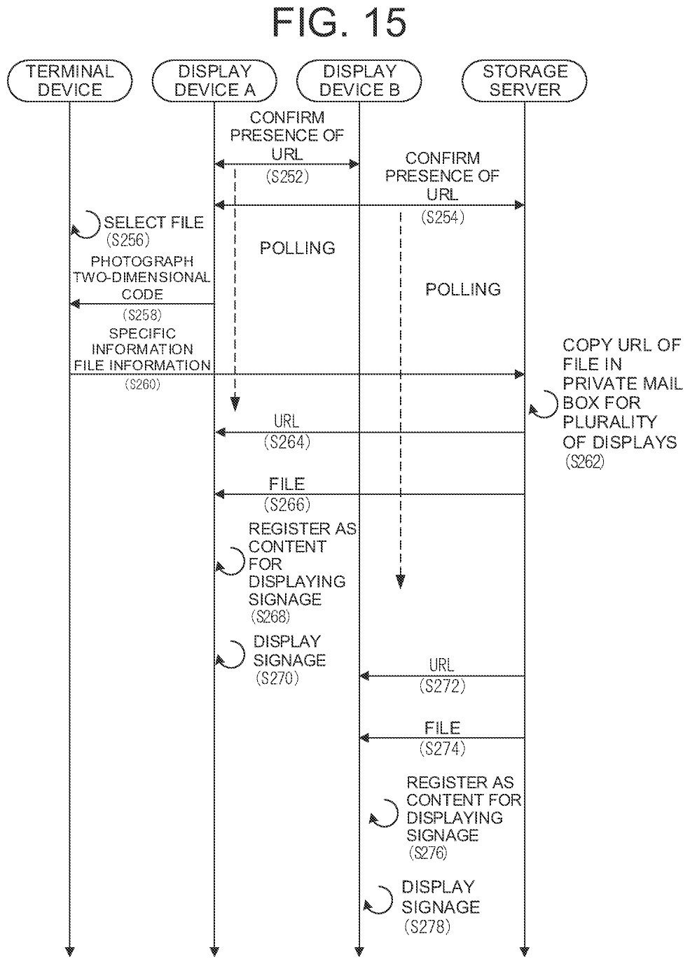

The flow of processing of the present embodiment will be described with reference to FIGS. 14 and 15. In the description of the flow of processing in the present embodiment, it is assumed that the display system 1 includes two display devices 20, which are referred to as a display device 20A and a display device 20B, respectively. In addition, it is assumed that no private mail box for plurality of displays is stored in the storage of the storage server 32, and management information is not stored in the management table 428 of the management server 42.

First, the processing illustrated in FIG. 14 will be described. FIG. 14 is a sequence diagram illustrating processing until the display device 20A and the display device 20B display the two-dimensional code.

The display device 20 (controller 200) transmits a request to register for plurality of displays to the management server 42 (S202). The request to register for plurality of displays is a request for providing a private mail box for plurality of displays in the storage server 32 to allow the display device 20 to acquire the URL stored in the private mail box for plurality of displays.

When transmitting the request to register for plurality of displays, the display device 20A (controller 200) also transmits device information that is information regarding the display device 20A. The device information to be transmitted is the same as the device information of S102 of the first embodiment.

When receiving the request to register for plurality of displays from the display device 20A, the management server 42 (controller 400) confirms whether there is a private mail box for plurality of displays of the same group as the group to which the display device 20A belongs (S204). Specifically, the management server 42 (controller 400) searches for management information in which the group name included in the device information received from the display device 20A is stored. If the management information is found as a result of the search, the management server 42 (controller 400) determines that there is a private mail box for plurality of displays of the same group as the group to which the display device 20A belongs. If the management information is not found as a result of the search, the management server 42 (controller 400) determines that there is no private mail box for plurality of displays of the same group as the group to which the display device 20A belongs.

In S204, since the management information is not stored in the management table 428, the management server 42 (controller 400) determines that there is no private mail box for plurality of displays of the same group as the group to which the display device 20A belongs.

The management server 42 (controller 400) transmits a request to create a private mail box for plurality of displays to the storage server 32 (S206).

When receiving the request to create a private mail box for plurality of displays, the storage server 32 (controller 300) creates (secures) a private mail box for plurality of displays 326 in the storage 320, and creates a two-dimensional code indicating specific information of the private mail box for plurality of displays 326 (S208). For example, the two-dimensional code may be information indicating the URL of the private mail box for plurality of displays 326, or may be information indicating the name of the private mail box for plurality of displays 326 (the name of a private mail box for plurality of displays).

The storage server 32 (controller 300) transmits the URL that is the address of the private mail box for plurality of displays 326 and the two-dimensional code, to the management server 42 (S210).

The management server 42 (controller 400) registers a device (display device 20A) in the private mail box for plurality of displays created in the storage server 32 (S212). Specifically, the management server 42 (controller 400) determines the name of the private mail box for plurality of displays. Then, the management server 42 (controller 400) stores, in the management table 428, management information including the name of the private mail box for plurality of displays, the device information (for example, the MAC address) transmitted from the display device 20A in S202, the group name of the group to which the display device 20A belongs, and the address of the private mail box for plurality of displays (the URL in the present embodiment) transmitted from the storage server 32 in S210. In addition, the management server 42 (controller 400) stores the two-dimensional code transmitted in S210 in the two-dimensional code storage area 430 after making the two-dimensional code identifiable by the name of the private mail box for plurality of displays. For example, when saving the two-dimensional code as an image file, the management server 42 (controller 400) assigns the name of the private mail box for plurality of displays to the file name of the image file, thereby making the two-dimensional code identifiable by the name of the private mail box for plurality of displays.

Subsequently, the management server 42 (controller 400) transmits, to the display device 20A, the two-dimensional code indicating the address of the private mail box for plurality of displays of the group to which the display device 20A belongs and the specific information of the private mail box for plurality of displays (S214). Here, for example, the management server 42 (controller 400) extracts, from the management table 428, the management information in which the group name included in the device information received from the display device 20A is stored. Then, the management server 42 (controller 400) acquires the URL stored in the extracted management information as the address of the private mail box for plurality of displays of the group to which the display device 20A belongs. In addition, the management server 42 (controller 400) acquires, from the two-dimensional code storage area 430, the two-dimensional code corresponding to the name of the private mail box for plurality of displays stored in the extracted management information.

The display device 20A (controller 200) stores the address (URL in the present embodiment) of the private mail box for plurality of displays received from the management server 42 as the private mail box address 248, and stores the two-dimensional code received from the management server 42 as the two-dimensional code 250.

Subsequently, the display device 20A (two-dimensional code displayer 204) reads out the two-dimensional code 250 and displays (outputs) the two-dimensional code on the displayer 220 (S216). As a result, the display device 20A displays the two-dimensional code indicating the specific information of the private mail box for plurality of displays.

Meanwhile, the display device 20B (controller 200) also transmits a request to register for plurality of displays to the management server 42 together with the device information (S218).

When receiving the request to register for plurality of displays from the display device 20B, the management server 42 (controller 400) confirms whether there is a private mail box for plurality of displays of the same group as the group to which the display device 20B belongs (S220). The processing in S220 is the same processing as in S204.

If there is a private mail box for plurality of displays of the same group as the group to which the display device 20B belongs, the management server 42 (controller 400) registers a device (display device 20B) in the private mail box for plurality of displays (S222). Specifically, the management server 42 (controller 400) reads out, from the management table 428, the management information in which the group name of the group to which the display device 20B belongs is stored. Then, the management server 42 (controller 400) stores the device information (for example, the MAC address) of the display device 20B, in the device information of the read management information.

If there is no private mail box for plurality of displays of the same group as the group to which the display device 20B belongs, the same processing as in S206 to S212 is performed. Specifically, the management server 42 (controller 400) transmits a request to create a private mail box for plurality of displays to the storage server 32 (S224). When receiving the request to create a private mail box for plurality of displays, the storage server 32 (controller 300) creates (secures) a private mail box for plurality of displays 326 in the storage 320, and creates a two-dimensional code indicating specific information of the private mail box for plurality of displays 326 (S226). The storage server 32 (controller 300) transmits the URL that is the address of the private mail box for plurality of displays and the two-dimensional code, to the management server 42 (S228). The management server 42 (controller 400) registers a device (display device 20B) in the private mail box for plurality of displays created in the storage server 32 (S230).

Subsequently, the management server 42 (controller 400) transmits, to the display device 20B, the URL that is the address of the private mail box for plurality of displays of the group to which the display device 20B belongs and the two-dimensional code indicating the specific information of the private mail box for plurality of displays (S232). This processing is the same processing as in S214. In addition, in the display device 20B, the address of the private mail box for plurality of displays 326 (URL in the present embodiment) is stored in the private mail box address 248, and a two-dimensional code indicating the specific information of the private mail box for plurality of displays is stored in the two-dimensional code 250.

Subsequently, the display device 20B (two-dimensional code displayer 204) reads out the two-dimensional code 250 and displays (outputs) the two-dimensional code on the displayer 220 (S234). As a result, the display device 20B displays the two-dimensional code capable of identifying the private mail box for plurality of displays.

If the display device 20A and the display device 20B belong to the same group, the display device 20A and the display device 20B display the same two-dimensional code. In this way, since the same two-dimensional code is displayed on the display devices 20 belonging to the same group, the terminal device 10 can acquire the same specific information from the display devices 20 belonging to the same group.

Subsequently, the processing illustrated in FIG. 14 will be described. FIG. 14 is a sequence diagram illustrating processing until the display device 20A and the display device 20B perform the signage display. In the following description, the display device 20A and the display device 20B will be described as being associated with the same private mail box for plurality of displays (belonging to the same group).

The display device 20A (controller 200) and the display device 20B (controller 200) start polling for periodically confirming whether the acquisition information (the URL of the file in the present embodiment) is stored in the private mail box for plurality of displays 326 of the storage server 32 identified by the private mail box address 248 (S252, S254).

The terminal device 10 (file displayer 102) selects and displays a file on the basis of the user's operation (S256). The terminal device 10 (controller 100) photographs the two-dimensional code displayed on the displayer 220 of the display device 20 (for example, the display device 20A) with the use of the image inputter 140 on the basis of the user's operation, and analyzes the two-dimensional code, thereby acquiring specific information (S258). The terminal device 10 (controller 100) transmits the specific information acquired in S258 and the information of the file selected in S256 to the storage server 32 identified by the storage server address 154, on the basis of the user's operation (S260). The processing in S256 to S260 is the same processing as in S118 to S122 of the first embodiment.

The storage server 32 (controller 300) identifies the private mail box on the basis of the specific information acquired from the terminal device 10. The storage server 32 (controller 300) stores (copies), in the identified private mail box, the URL of the file as the file acquisition information based on the file information transmitted from the terminal device 10 (S262). Here, in S160, since the specific information of the private mail box for plurality of displays 326 is transmitted from the terminal device 10, the storage server 30 (controller 300) identifies the private mail box for plurality of displays 326 as the private mail box for storing the URL.

For example, the storage server 32 (controller 300) identifies the URL of the private mail box for plurality of displays 326 from the specific information acquired from the terminal device 10. For example, if the specific information is the name of the private mail box for plurality of displays 326, the storage server 32 (controller 300) refers to the management table, reads out the management information in which the name of the private mail box is stored, and identifies the URL of the private mail box for plurality of displays 326. If the specific information acquired from the terminal device 10 is the URL of the private mail box for plurality of displays 326, the storage server 32 (controller 300) identifies the URL as the URL of the private mail box for plurality of displays 326.

Subsequently, the storage server 32 (controller 300) stores (copies), in the private mail box for plurality of displays 326 stored in the identified URL, the file acquisition information (the URL of the file in the present embodiment) indicated by the file information. In S262, the processing for storing the URL of the file in the private mail box for plurality of displays 326 is the same processing as in S124 of the first embodiment.

The display device 20A (controller 200) detects that the URL which is the acquisition information is stored in the private mail box. In this case, the display device 20A (controller 200) acquires the URL of the file stored in the private mail box (S264). In addition, the display device 20A (controller 200) acquires the newly added file from the storage server 32 on the basis of the acquired URL (S266), and registers the acquired file as signage content (S268). The display device 20A (signage displayer 202) starts signage display (S270). The processing in S264 to S270 is the same as in S126 to S132 of the first embodiment.

In addition, the display device 20B (controller 200) detects that the URL of the file which is the acquisition information is stored in the private mail box. In this case, the display device 20B (controller 200) acquires the URL of the file stored in the private mail box (S272). In addition, the display device 20B (controller 200) acquires the newly added file from the storage server 32 on the basis of the acquired URL (S274), and registers the acquired file as signage content (S276). The display device 20B (signage displayer 202) starts signage display (S278). The processing in S272 to S278 is the same as in S126 to S132 of the first embodiment.

Since the display device 20A and the display device 20B belong to the same group, the same acquisition information is transmitted from the storage server 32 in S262 and S272. Therefore, the display device 20A and the display device 20B can acquire the same file and can display the same content.

As in the first embodiment, the display device 20 may display the content on the basis of the restriction information. For example, by including information regarding the attributes of the file in the restriction information, the display device 20 displays the content on the basis of the capacity of the display device 20. In addition, in the present embodiment, the restriction information may be information that specifies (limits) the display device 20 that displays the content. For example, in the terminal device 10, a location where the file can be displayed can be specified by the user. In this case, in S260, the terminal device 10 (controller 100) also transmits information of the location where the file can be displayed. In this case, in S262, the storage server 32 (controller 300) adds the location information transmitted from the terminal device 10 to the end or the like of the URL as the restriction information.

When acquiring the URL from the storage server 32 in S264 and S272, the display device 20 (controller 200) determines whether the location information added to the URL and the location information stored in the setting information 254 match. If the location information added to the URL and the location information stored in the setting information 254 match, the display device 20 (controller 200) stores the URL in the reception list 242, and if they do not match, the display device 20 does not store the URL in the reception list 242. By configuring in this manner, in S264 and S272, the display device 20 can add only the displayable files to the playlist 246 and acquire them from the storage server 32 in S266 and S274. The information that specifies (limits) the display device 20 that displays the content may be information such as a model name, a latitude/longitude, and an organization name.

By configuring in this manner, even when the private mail box is shared by a plurality of display devices 20, it is possible to appropriately display the content depending on the capacity and the installation locations of the display devices 20.

In the present embodiment, the file display time may be added as the restriction information as in the first embodiment. In that case, the display device 20 (controller 200) stores the display time based on the restriction information in the playlist 246 in S268 and S276. When the display time of the file is not specified, the display device 20 (controller 200) stores the display time based on the display condition 244, in the playlist 246 in S268 and S276.

In addition, the present embodiment may be combined with the first embodiment. In this case, the storage server 32 stores two private mail boxes, the private mail box 322 and the private mail box for plurality of displays 326. The display device 20 acquires the URLs of the two private mail boxes and the two-dimensional codes corresponding to respective private mail boxes via the management server 40. The display device 20 displays two-dimensional codes, periodically confirms the presence of the URLs, and acquires the URLs from the two private mail boxes. The storage server 32 receives the file information and the specific information obtained from the two-dimensional code from the terminal device 10, and stores the file acquisition information identified by the file information, in the private mail box identified by the specific information. As a result, the display device 20 can acquire the acquisition information from the private mail box 322 and the private mail box for plurality of displays 326. The display device 20 stores two playlists, a playlist for displaying the file acquired on the basis of the acquisition information acquired from the private mail box 322 and a playlist for displaying the file acquired on the basis of the acquisition information acquired from the private mail box for plurality of displays 326. When acquiring the file from the private mail box 322 and the file from the private mail box 326, the display device 20 adds the file name and the display time of the acquired file to a corresponding playlist. In addition, the signage displayer 202 performs signage display based on one of the playlists on the basis of the user's operation.

According to the present embodiment, the private mail box is shared by a plurality of display devices 20. Therefore, the user can display content on a plurality of display devices simply by transmitting the file information and the information for identifying the private mail box (for example, a two-dimensional code) to the storage server with the use of the terminal device.

### 3. Third Embodiment

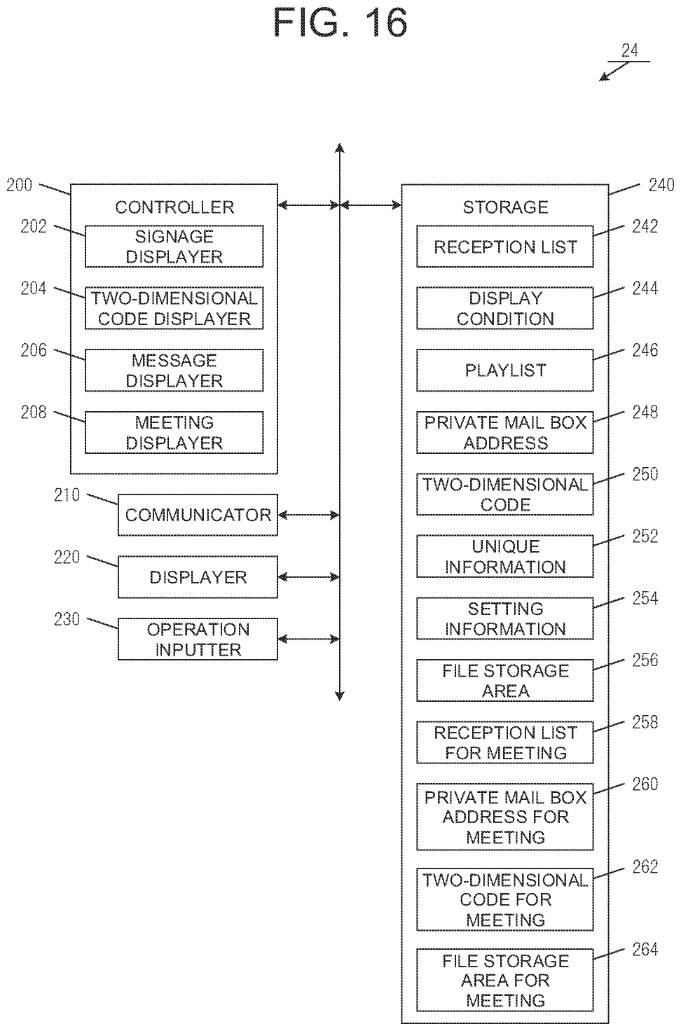

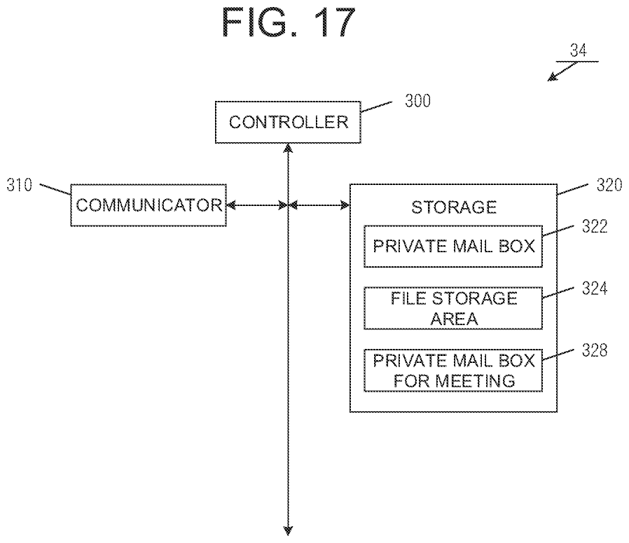

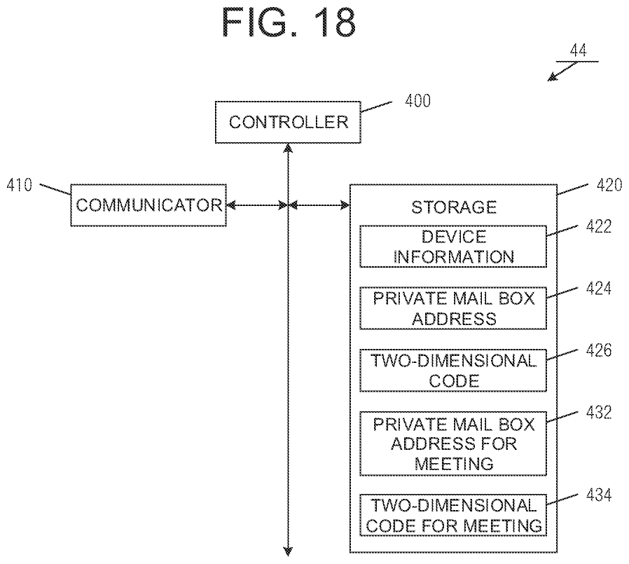

In a third embodiment, a private mail box different from the private mail box described in the first embodiment is further associated with the display device 20. In the third embodiment, FIG. 3 of the first embodiment is replaced with FIG. 16, FIG. 4 of the first embodiment is replaced with FIG. 17, and FIG. 5 of the first embodiment is replaced with FIG. 18, respectively, and the same functional units and processing are denoted by the same reference numerals, and the description thereof will be omitted.

In the present embodiment, a private mail box different from the private mail box described in the first embodiment is described as a private mail box for meeting.

In the present embodiment, the display system 1 includes a display device 24 as an alternative to the display device 20, a storage server 34 as an alternative to the storage server 30, and a management server 44 as an alternative to the management server 40.

The functional configuration of the display device 24 in the present embodiment will be described with reference to FIG. 16. Unlike the display device 20, the display device 24 further stores a reception list for meeting 258, a private mail box address for meeting 260, and a two-dimensional code for meeting 262 in the storage 240, and further secures a file storage area for meeting 264 as an area for storing a file for meeting.

The reception list for meeting 258 is a list that stores one or more URLs received from the private mail box for meeting corresponding to the display device 24. The private mail box for meeting will be described later.

The private mail box address for meeting 260 is the address of the private mail box for meeting corresponding to the display device 24, and is, for example, a URL, an IP address, a MAC address, or the like. In the present embodiment, the address of the private mail box will be described as a URL. In addition, the two-dimensional code for meeting 262 is a two-dimensional code indicating specific information (second specific information) of the private mail box for meeting corresponding to the display device 24.

In addition, the controller 200 functions as a meeting displayer 208 by reading and executing a program stored in the storage 240.

The meeting displayer 208 is a functional unit that implements meeting display. The meeting display is a display method for reading a predetermined file and displaying the content stored in the read file on the displayer 220 on the basis of the user's operation.

The meeting displayer 208 reads out the file stored in the file storage area for meeting 264 by the user's operation, and displays the content stored in the read file on the displayer 220 on the basis of the user's operation. In the present embodiment, in the meeting display, the user can perform operations such as file selection, page turning, and enlargement/reduction. In addition, the user's operation is input via, for example, a remote controller.

In the present embodiment, the two-dimensional code displayer 204 displays two types of two-dimensional codes, the two-dimensional code 250 and two-dimensional code for meeting 262.

The functional configuration of the storage server 34 in the present embodiment will be described with reference to FIG. 17. Unlike the storage server 30, the storage server 34 further secures, in the storage 320, a private mail box for meeting 328 in addition to the private mail box 322.

The private mail box for meeting 328 is an area for storing acquisition information (acquisition information storage area). The private mail box for meeting 328 is, for example, a folder in which a shortcut file indicating the URL of a file is stored, similarly to the private mail box 322 of the first embodiment. In the private mail box for meeting 328, URL information of one or more files may be stored, and for example, text data or a database may be stored. The private mail box for meeting 328 is created (secured) for each display device 24 as in the first embodiment.

The functional configuration of the management server 44 in the present embodiment will be described with reference to FIG. 18. Unlike the management server 40, the management server 44 further stores, in the storage 420, a private mail box address for meeting 432 and a two-dimensional code for meeting 434.

The private mail box address for meeting 432 is the address of a private mail box for meeting corresponding to the display device 24. The two-dimensional code for meeting 434 is a two-dimensional code indicating specific information of the private mail box for meeting corresponding to the display device 24.

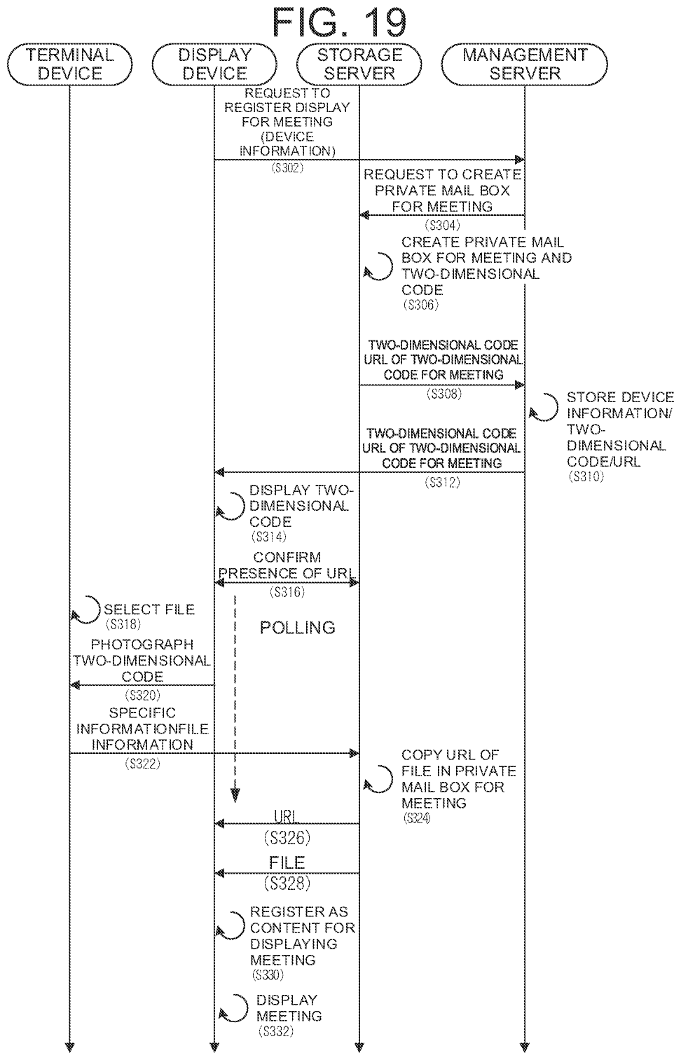

The flow of processing of the present embodiment will be described with reference to FIG. 19. The processing illustrated in FIG. 19 is executed separately (in parallel) from the processing illustrated in FIG. 7 in the first embodiment.

First, the display device 24 (controller 200) transmits a request to register a display for meeting to the management server 44 (S302). The request to register a display for meeting is a request for the display device 24 to be able to acquire the URL stored in the private mail box for meeting of the storage server 34.

When transmitting the request to register a display for meeting, the display device 24 (controller 200) also transmits information (device information) regarding the display device 24. The processing in 5302 is the same processing as in 5102 of the first embodiment.

When receiving the request to register a display for meeting from the display device 24, the management server 44 (controller 400) transmits a request to create a private mail box for meeting to the storage server 34 (S304).

When receiving the request to create a private mail box for meeting, the storage server 34 (controller 300) creates (secures) the private mail box for meeting 328 in the storage 320, and further creates a two-dimensional code indicating the specific information (second specific information) with which the private mail box for meeting 328 can be identified (S306). For example, the storage server 34 (controller 300) creates a two-dimensional code by encoding the URL of the private mail box for meeting 328 in a predetermined format. For example, the storage server 34 (controller 300) creates a two-dimensional code by encoding the URL of the private mail box for meeting 328 in a predetermined format.

The storage server 34 (controller 300) may create a two-dimensional code on the basis of the attribute information such as the name, file path, and ID of the private mail box for meeting 328 as long as the private mail box for meeting 328 can be identified with the information.

The storage server 34 (controller 300) transmits the URL that is the address of the private mail box for meeting 328 and the two-dimensional code indicating the specific information (second specific information) of the private mail box for meeting 328, to the management server 44 (S308).

In S402, the management server 44 (controller 400) stores the device information received from the display device 24 as the device information 422. In addition, the management server 44 (controller 400) stores the address (URL in the present embodiment) of the private mail box for meeting 328 and the two-dimensional code for meeting received from the storage server 34 in S408, as the private mail box address for meeting 432 and the two-dimensional code for meeting 434, respectively (S310).

The management server 44 (controller 400) transmits the private mail box address for meeting 432 and the two-dimensional code for meeting 434 to the display device 24 (S312). The display device 24 (controller 200) stores the private mail box address for meeting 432 received from the management server 44 as the private mail box address for meeting 260. In addition, the display device 24 (controller 200) stores the two-dimensional code for meeting 434 received from the management server 44 as the two-dimensional code for meeting 262.

Subsequently, the display device 24 (two-dimensional code displayer 204) reads out the two-dimensional code for meeting 262 and displays (outputs) the two-dimensional code for meeting on the displayer 220 (S314). By executing the processing illustrated in FIG. 19 and the processing illustrated in FIG. 7 in parallel, two types of two-dimensional codes, the two-dimensional code 250 corresponding to the private mail box 322 and the two-dimensional code for meeting 262 corresponding to the private mail box for meeting 328 are displayed on the displayer 220.

The display device 24 (controller 200) starts polling for periodically confirming whether the URL which is the acquisition information is stored in the private mail box for meeting 328 of the storage server 34 identified by the private mail box address for meeting 260 (S316).

The terminal device 10 (file displayer 102) selects and displays a file on the basis of the user's operation (S318). The terminal device 10 (controller 100) photographs the two-dimensional code displayed on the displayer 220 of the display device 24 with the use of the image inputter 140, on the basis of the user's operation, thereby acquiring the specific information (S320). In doing so, the terminal device 10 can acquire the specific information (second specific information) of the private mail box for meeting 328 by photographing the two-dimensional code for meeting 262. In addition, the terminal device 10 (controller 100) connects to the storage server 34 with the use of the storage server address 154 on the basis of the user's operation. Then, the terminal device 10 (controller 100) transmits the specific information (second specific information) acquired in S320 and the information of the file selected in S318 (S322). The processing in S256 to S260 is the same processing as in S118 to S122 of the first embodiment.

The storage server 34 (controller 300) receives the specific information (second specific information) and the file information transmitted from the terminal device 10 via the communicator 310. The storage server 34 (controller 300) identifies a private mail box on the basis of the specific information (second specific information), and generates the file acquisition information (second acquisition information. URL in the present embodiment) based on the file information transmitted from the terminal device 10, in the identified private mail box. As a result, the storage server 34 (controller 300) stores (copies) the file acquisition information in the private mail box (S324). The processing in S324 is the same processing as in S124 of the first embodiment.

Here, by the polling started in S316, the display device 24 (controller 200) detects that the acquisition information (URL) is stored in the private mail box for meeting 328. In this case, the display device 24 (controller 200) acquires the acquisition information (URL) stored in the private mail box for meeting 328 (S326). The display device 24 (controller 200) stores the acquired acquisition information (URL) in the reception list for meeting 258.

In doing so, the display device 24 (controller 200) compares the reception list for meeting 258 with the file stored in the file storage area for meeting 264, and detects a file newly added to the private mail box for meeting 328 and a file deleted from the private mail box for meeting 328. The detection method is the same as the detection method of the first embodiment, and the display device 24 (controller 200) deletes the file deleted from the private mail box for meeting 328 from the file storage area for meeting 264.

The display device 24 (controller 200) acquires the file newly added to the private mail box for meeting from the storage server 34 on the basis of the read URL (second acquisition information) (S328). In addition, the display device 24 (controller 200) stores the acquired file in the file storage area for meeting 264 to register the file as the content for displaying a meeting (S330). The display device 24 (controller 200) executes the processing illustrated in FIG. 19 and the processing illustrated in FIG. 7 in parallel, thereby separately acquiring files from the private mail box 322 identified by the two-dimensional code 250 and the private mail box for meeting 328 identified by the two-dimensional code for meeting 262. As a result, the display device 24 (controller 200) can acquire the file in accordance with the type of the two-dimensional code (type of the acquisition information) displayed on the displayer 220.

Subsequently, the display device 24 (meeting displayer 208) starts meeting display (S332). As a result, the display device 24 (meeting displayer 208) displays the content stored in the file stored in the file storage area for meeting 264 on the displayer 220. The display device 24 (meeting displayer 208) may execute the meeting display after the operation to start the meeting display is performed via the operation inputter 230. The file acquired from the private mail box 322 is stored in the file storage area 256 by the processing illustrated in FIG. 7, and the signage displayer 202 performs signage display. Therefore, the display device 24 can make, the method for displaying the content stored in the file acquired in accordance with the type of the two-dimensional code, different in accordance with the type of the two-dimensional code (type of the acquisition information) displayed on the displayer 220.

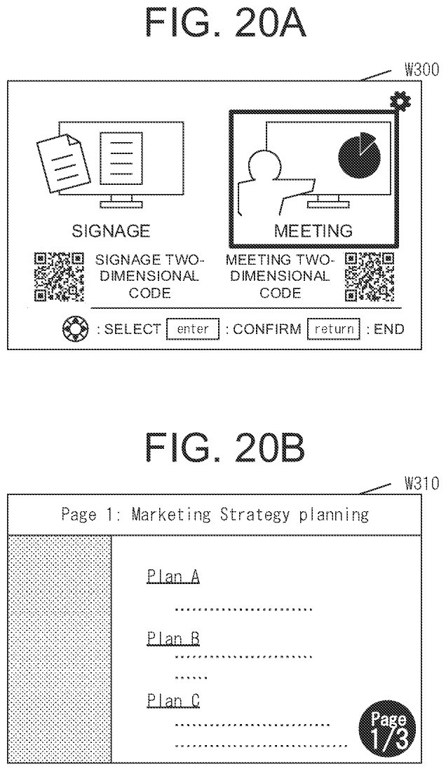

Subsequently, an example of operation in the present embodiment will be described with reference to FIGS. 20A and 20B. FIG. 20A is a display example of a menu screen W300 when the meeting display is selected as the content display method by a remote controller or the like. For example, by emphasizing the icon indicating the meeting display (for example, surrounding the icon with a frame, changing the background color, enlarging the icon, etc.), it is indicated that the meeting display is selected. When a start instruction is given in this state, the display of the content is started as illustrated in a display screen W210 of FIG. 20B. In this case, the user can select the content to be displayed, turn the page, and enlarge/reduce the content by using the remote controller or the like.

The private mail box for meetings described in the third embodiment is different from the private mail box described in the first embodiment. Therefore, different acquisition information (for example, a URL) is stored (copied) in each private mail box. As a result, the display device 24 separately acquires and stores the content for signage display and the content for meeting display. In addition, the content for signage display is displayed by the signage displayer 202, and the content for meeting display is displayed by the meeting displayer 108. As a result, the user can register the content for signage display and the content for meeting according to the purpose.

In addition, similarly to the first embodiment, in S324, the storage server 34 may add information indicating a time when the content can be displayed and information indicating the attributes of the file to the URL as restriction information. In this case, the display device 24 displays the content on the basis of the restriction information.

Moreover, similarly to the first embodiment, the storage server 34 may secure a plurality of meeting private mail boxes for meeting 328 in the storage 320, and the plurality of different private mail box for meeting 328 may be associated with respective different display devices 20 by the management server 44.

According to the present embodiment, when there is content (file) to be displayed on the display device at a meeting or the like, the user may select the file with the use of the terminal device and transmit the file information and the information for identifying the private mail box (for example, a two-dimensional code) to the storage server. As a result, the file selected by the user is displayed as content on the display device.

### 4. Variation

The present invention is not limited to the above-described embodiments, and various modifications can be made. That is, implementations obtained by combining techniques appropriately changed without departing from the gist of the present invention are also included in the technical scope of the present invention.

In addition, while the above-described embodiments have parts described separately for convenience of explanation, it is needless to say that the embodiments may be combined and executed within the technically possible range. For example, the second embodiment and the third embodiment may be combined, and the display device may acquire the content for signage display on the basis of the URL stored in the private mail box for plurality of displays, and acquire the content for meeting display on the basis of the URL stored in the private mail box for meeting secured for each display device.

In addition, the program that operates in each device in the embodiments is a program that controls a CPU or the like (a program that causes a computer to function) so as to implement the functions of the above-described embodiments. Moreover, the information handled by these devices is temporarily stored in a temporary storage device (for example, a RAM) at the time of processing, and then stored in various storage devices such as a ROM (Read Only Memory) and an HDD, and is read, corrected, and written by the CPU as needed.

Here, as the recording medium for storing the program, a semiconductor medium (for example, a ROM, a non-volatile memory card, etc.), an optical recording medium/magneto-optical recording medium (for example, a DVD (Digital Versatile Disc), an MO (Magneto Optical Disc), an MD (Mini Disc), a CD (Compact Disc), a BD (Blu-ray Disk), etc.), a magnetic recording medium (for example, a magnetic tape, a flexible disk, etc.) or the like may be used. In addition, the functions of the above-described embodiments are implemented by executing a loaded program. In some cases, the functions of the present invention are implemented by processing in collaboration with the operating system or an other application program on the basis of the instructions of the program.

Furthermore, in the case of distribution to the market, the program can be stored and distributed in a portable recording medium, or transferred to a server computer connected via a network such as the Internet. In this case, it goes without saying that the storage device of the server computer is also included in the present invention.

What is claimed is:

1. A display system comprising:
a display device that displays content on a basis of a playlist; a terminal device; and a server device,
wherein the terminal device transmits specific information acquired from the display device and content information regarding content, from the terminal device to the server device,
wherein the server device transmits acquisition information generated by the specific information and the content information, to the display device, and
wherein the display device adds the content to the playlist on a basis of the acquisition information.

2. The display system according to claim 1,
wherein the server device generates an area for storing the content information, and
wherein the specific information indicates that the specific information is information for identifying the area for storing the content information.

3. The display system according to claim 1, wherein the specific information is information indicating a URL (Uniform Resource Locator).

4. The display system according to claim 1, wherein the display device displays an image encoded. on a basis of the specific information.

5. The display system according to claim 1, wherein the display device acquires the content on a basis of the acquisition information.

6. The display system according to claim 5,
wherein the acquisition information includes restriction information, and
wherein the display device displays content on a basis of the restriction information.

7. The display system according to claim 6, wherein the display device refers to the restriction information and displays the content only for a displayable time.

8. The display system according to claim 6, wherein the display device refers to the restriction information, and when the content can be displayed on the display device, the display device acquires the content and displays the acquired content.

9. The display system according to claim 1,
wherein the terminal device can acquire a same piece of the specific information from a plurality of the display device, and
wherein the server device transmits the same acquisition information. to the display device capable of acquiring the same piece of the specific information.

10. The display system according to claim 1,
wherein the terminal device can acquire, from the display device, second specific information different from the specific information,
wherein the server device transmits the second specific information and second acquisition information generated by the content information, to the display device, and
wherein the display device displays content based on the second acquisition information in accordance with an operation of a user.

11. A display device that displays content on a basis of a playlist, the display device comprising:
an outputter that outputs specific information;
a communicator that communicates with a server device that generates acquisition information; and
an adder that adds the content to the playlist on a basis of the acquisition information,
wherein the acquisition information is information generated by the specific information and file information transmitted from the terminal device that has acquired the specific information to the server device.
